(19) United States
(12) Patent Application Publication
(10) Pub. No.: US 2002/0073144 A1
(43) Pub. Date: Jun. 13, 2002

(54) Method and system for providing information recording service, and recording medium and computer program product therefor

(75) Inventors: Hitoshi Katoh, Yamato-shi (JP); Masayuki Shibukwa, Yamato-shi (JP)

Correspondence Address: IBM CORPORATION, INTELLECTUAL PROPERTY LAW DEPT., P.O. BOX 218, YORKTOWN HEIGHTS, NY, 10598, US

(73) Assignee: International Business Machines Corporation, Armonk, NY (US)

(21) Appl. No.: 09/960,420

(22) Filed: Sep. 21, 2001

(30) Foreign Application Priority Data
Sep. 29, 2000 (JP) 2000-300835

(51) Int. Cl. G06F 15/16; G09G 5/00

(52) U.S. Cl. 709/203; 345/748

(57) ABSTRACT

Provides an efficient information recording service, such as a printing service, for electronic data that is read or distributed. An example embodiment includes a printing provider computer, a vendor computer and a client computer are connected to the Internet. Upon the receipt of a request from the client computer, the vendor computer transmits, to the client computer, display data that includes anchor information used for establishing a link with the printing provider computer. When a printing service request button that is correlated with the anchor information on the display is selected, the printing provider computer accepts the printing application, displays an application input screen, and obtains client information. The printing provider computer also obtains a print file, prints the data and transmits the obtained printed material in accordance with the client information.

### FIELD OF THE INVENTION

The present invention relates to a method and system for providing an information recording service, such as the printing of electronic data on paper. In particular, the present invention pertains to an effective technique applied for out-sourcing data recording operations, such as the printing of data, across the Internet.

### BACKGROUND

Vendors of products must universally furnish clients reference materials, such as catalogues, pamphlets and manuals. Traditionally, such materials have been provided as printed paper media. However, in line with recent improvements in information processing methods and the development and widespread employment of Internet distribution techniques, services have appeared whereby the Internet is employed for the transmission and the reading of reference materials in an electronic data form. When a material scanning system is employed, a savings in paper resources can be realized and printing and transportation costs reduced, making it possible for a client to read reference material, as needed, while enjoying a reduced product cost engendered by reductions in the costs of producing and distributing reference materials. Further, should a client desire a hard copy of the reference material, he or she can simply download the material as electronic data and use a printer to record the data on paper.

However, a manual for a high-level product, such as a computer system, is so voluminous that a user would have to assume an excessively large work load in order to download the included data and output it to a printer. And under certain circumstances, the amount of data involved could even exceed the processing capability of a printer. Note that when a product is an electronic book, a user tends to desire that the data be provided as printed material.

Since the need for data to be printed on paper exists even when electronic data materials and books are available, a vendor must arrange for a service for providing printed matter. When a vendor personally assumes the responsibility of providing printed matter, that vendor must not only arrange for the printing of reference materials but also for their delivery. Thus, since for jobbers other than specialty jobbers, these arrangements increase handling costs, generally, jobbers contract out the printing and distribution of reference material to special printing jobbers.

Problems to be Solved by the Invention

As is described above, when the printing of manuals of electronic data is entrusted to special printing jobbers, the operation can be simplified, and to a degree, reductions in costs can be realized. However, under these circumstances a vendor is still responsible for the acceptance of printed material requests from clients, and for notifying a printing jobber of the contents of a client's application and transmitting the latest relevant data to the printing jobber. Therefore, when implementing a service operation and responding to the request of a client for printed material, only limited cost reductions that can be realized.

Furthermore, since it is common for the forms required for jobs entrusted to printing jobbers to differ, depending on the printing targets or the vendors, printing jobbers must cope with the printing of a great variety of forms. Since the complexity this involves impedes attempts by printing jobbers to improve their performances, they are prevented from realizing cost reductions through the rationalization of their operations.

### SUMMARY OF THE INVENTION

It is therefore one aspect of the present invention to provide a service provision method and system for providing a recording service, such as the efficient printing of electronic data that has been scanned or distributed.

It is another aspect of the present invention to provide an information recording service, such as data printing, that imposes only an extremely small load on a vendor.

It is an additional aspect of the present invention to provide a standardized service provision method for a service provider, such as a printing jobber, for providing an information recording service.

### BRIEF DESCRIPTION OF THE DRAWINGS

The foregoing and further aspects and advantages of this invention will become more apparent from a consideration of the following description, the appended claims, and the accompanying drawings, in which:

FIG. 1 is an example diagram showing an overview of a printing service provision system according to one embodiment of the present invention;

FIG. 2 is an example block diagram showing the configurations of a printing provider computer, a vendor computer and a client computer;

FIG. 3 is an example flowchart showing an example information recording service provision method according to the embodiment;

FIG. 4 is an example diagram showing an example display for a product search screen;

FIG. 5 is an example diagram showing an example product introduction screen display for search results;

FIG. 6 is an example diagram showing an example display for an application input screen; and

FIG. 7 is an example diagram showing an example display for an application completed screen.

### DESCRIPTION OF THE SYMBOLS

1: Internet

2: Printing provider computer

2a: Web server

2b: Application relay function

2c: Application acceptance function

2d: Print file acquisition function

3: Printer

4: Vendor computer

4a: Web server

5: Print file

6: Client computer

6a: Web client

7a: Product search screen

7b: Product introduction screen

7c: Application input screen

7d: Application complete screen

30: Input field

31: Search button

32: Printing service request button

33, 34: Input fields

35: Printing service request button

### DESCRIPTION OF THE INVENTION

An overview of the invention is as follows. In an information recording service provision system for this invention, the computer of a service provider who provides a service for recording documents, drawings and other information, the computer of a data provider who provides target data for the information, and the computer of a client who uses the service to record the information are interconnected by a network. In response to a request forwarded by the client computer to the data provider computer, display data, including anchor information used for establishing a link with the service provider computer, is transmitted to the client computer. Then, an image corresponding to the display data is displayed on the screen of the client computer, and from the display data, text or an image, correlated with the anchor information, is selected. In response to this selection, the service provider computer that is linked to the client computer initiates the processing, and transmits, to the client computer, data for an information recording request screen. When the information recording request screen has been displayed, client information and other information is entered, and is transmitted to the service provider computer. The service provider computer obtains and records the target data, and transmits the recorded material to the client in accordance with the client information.

According to the present invention, tag information that is linked to the service provider (e.g., a printing jobber) need only be inserted into the web page of a data provider (a vendor), so that a recording service, such as one for the printing of electronic data, can be provided for the client, while an extremely small load is imposed on the data provider. That is, since the recorded material for electronic data, such as the printed material, is collected by the service provider from the recording request screen that it has issued, the data provider need not manage the recording request (printing request) submitted by the client. Further, since data to be recorded, such as data to be printed, is obtained by the service provider when the request application is accepted, so long as the recording location of the target is identified, the data provider need only update the data recorded at this location. Therefore, the data provider must merely update the target data recorded at a predetermined address and can always provide updated data to the client, without having to perform an operation to provide the service provider the latest data.

Whereas, only when requesting anchor tag information to be inserted into the web page of a vender, a service provider, such as a printing jobber, can standardize an application form used to request that a client submit a printing application to his or her own server (service provider).

Therefore, the operation concerning the submission of a printing request can be simplified, and efficiency of the operation efficiency improved. Further, for the printing service, a POD (Print On Demand) printer is employed for the printing process (information recording process), so that the entire process, from the acquisition of print data to the actual printing, can be automated.

In order to search for information and to submit a printing or recording request application accompanied by the search results, a client need only select buttons while reading the web page, and does not need to know which server is handling the process. That is, for a recording or a printing request process, the client need only move the web page in accordance with the links by which the buttons are connected, and enter necessary information as requested. Thus, for a client, a convenient information recording request system can be provided.

The anchor information can include address information for a linking destination, the title of the target data, the recording location and other attribute information. Further, attribute information or a session management ID can be included as a hidden tag in the information recording request screen data, and can be transmitted with the client information that is input. Furthermore, the attribute information can be correlated with the session management ID, and the target data can be obtained by referring to the recording location of the target data, which is included in the attribute information transmitted with the client information, or the attribute information correlated with the session management ID.

Advantageous Embodiments

An example of an advantageous embodiment of the present invention will now be described in detail. It should be noted, however, that the present invention can be carried out by various other embodiments, and is not limited to this embodiment. The same reference numerals are used through the embodiment to denote corresponding or identical components.

In this embodiment, mainly the method or the system will be described. However, as will be obvious to one having ordinary skill in the art, the present invention can be implemented not only as the method or the system, but also as a recording medium on which computer-readable program code is recorded. Therefore, the present invention can be provided as hardware or software, or as a combination of the two. An example recording medium on which program code is recorded can be an arbitrary computer-readable recording medium, such as a hard disk, a CD-ROM, an optical storage device, or a magnetic storage device.

The computer system used for this embodiment comprises a central processing unit (CPU), a main memory (RAM (Random Access Memory)) and a nonvolatile storage device (ROM (Read Only Memory)), which are interconnected by a bus. In addition, a co-processor, an image accelerator, a cache memory and an input/output controller (I/O) are connected to the bus. Further, an external storage device, a data input device, a display device or a communication controller may also be connected to the bus. Other hardware resources with which a computer system is ordinarily equipped can also be provided. An example storage device can be a hard disk drive, and a magneto-optical storage device, an optical storage device or a semiconductor storage device, such as a flash memory, can also be included as an external storage device. A read-only storage device, such as a CD-ROM, which is used only for reading data, can also be included as an external storage device when that device is used only for reading data or a program. An input device, such as a keyboard, and a pointing device, such as a mouse, can also be provided as data input devices, as can a voice input device. An example display device is a CRT, a liquid crystal display device or a plasma display device. The computer systems used in this embodiment include arbitrary types of computers, such as personal computers, workstations or main frame computers.

The computer system of this embodiment can be used as a single computer system; however, it can also be used as a network comprising multiple computer systems. In this case, the Internet, a LAN or a WAN can be employed for communication among the computer systems. The communication line used for this connection can be either a private line or a public network line.

To carry out the invention using multiple computer systems, the program used by each computer system may be recorded in another computer system (e.g., a server computer). In other words, one part of the program used by the computer system can be distributed and processed by a remote computer (e.g., another server computer or a client computer). When an address is used to refer to a program recorded in another computer system, a DNS, a URL or an IP address can be employed. The data explained in this embodiment may be distributively recorded. Data that is distributively recorded can be accessed by designating a storage location using a DNS, a URL or an IP address.

It should be noted that when remarks are made concerning the Internet, these remarks also apply to intranets and extranets. And that references to Internet access also refer to intranet and extranet accesses. Note also that the term “computer network” is used to describe both a network that can be accessed publicly and a network to which only private access is permitted.

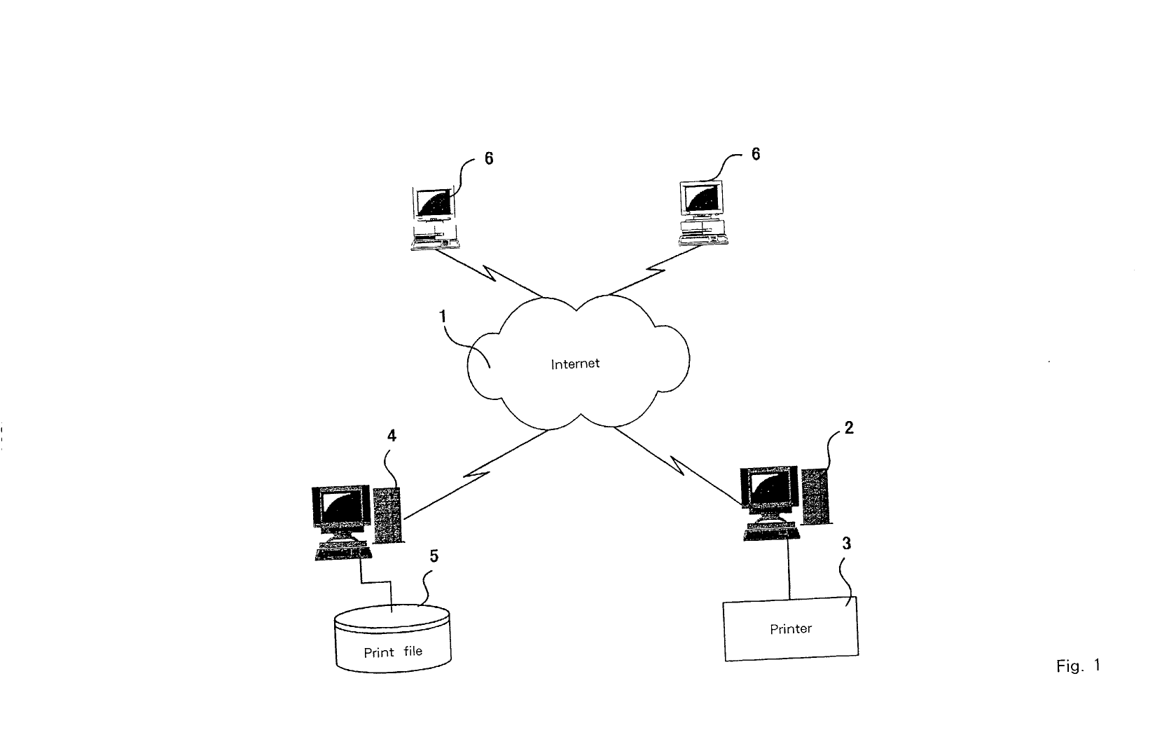

FIG. 1 is a diagram showing the overview of a printing service provision system according to this embodiment. This service provision system includes the Internet 1, to which a printing provider computer 2, a vender computer 4 and client computers 6 are connected.

As is well known to one having ordinary skill in the art, the Internet 1 is a computer network accessible in accordance with the TCP/IP (Transmission Control Protocol/Internet Protocol) or the UDP (User Datagram Protocol) communication protocols.

The printing provider computer 2 is the computer system of a printing provider who provides an information recording service in accordance with the embodiment. In this embodiment, printing on paper is used as an example service for the recording of information (electronic data); however, the service is not limited to this, and a service can be provided for recording information (electronic data) on a CD-ROM, for example. A printer 3 is connected to the printing provider computer 2.

The vendor computer 4 is a computer system for a vender of products. Normally, documents, such as manuals or pamphlets, accompany the products, and the vendor permits the vendor computer 4 to read in these documents as electronic data. The printing service of this embodiment relates to a service whereby, instead of a vendor, a printing provider prints documents and delivers printed materials to a client. The vendor, however, is responsible for supplying electronic data, the contents of the printed material. And therefore, in this embodiment the vendor is understood to be the provider of the electronic data. The electronic data to be printed is not limited to the data that accompanies products, such as manuals, and may be a product, such as an electronic book, whose electronic data is the target of a sales transaction. Further, the electronic data need not always be related to products, and may be employed for a service whereby a hard copy of the image of a web page or the contents of a web page are obtained. Furthermore, the electronic data is not limited to document, and may be applied, for example, to provide a service for the downloading of music or of moving picture data and the recording of the data on a recording medium, such as a CD-ROM or a DVD-ROM. Electronic data are recorded in a print file 5, and an example device used for the recording of the print file 5 is a hard disk drive mounted in the vendor computer 4. It should be noted that the recording area for the print file 5 need not be prepared in the same system as the vendor computer 4. So long as the recording area of the print file 5 can be designated by using a URL, the print file 5 may be recorded in the area of another computer system connected to the Internet 1.

The client computer 6 is a computer of a client who uses the service system of this embodiment. As will be described later, the client accesses the vendor computer 4 to read the web page of the vendor, and clicks on a printing request button when he or she desires to print desired electronic data. Subsequently, after having entered required data using a predetermined application screen, the client receives printed material, the content of which is the desired electronic data.

Multiple computers may be employed as the printing provider computers 2, the vendor computers 4 and the client computers 6 of the system in this embodiment. Normally, there are multiple clients and multiple vendors, but there may be only a single or multiple printing providers. When there are multiple printing providers, in consideration of the geographical distance to a client or of communication and delivery costs, a printing provider will be automatically connected for which the aggregate costs are the lowest.

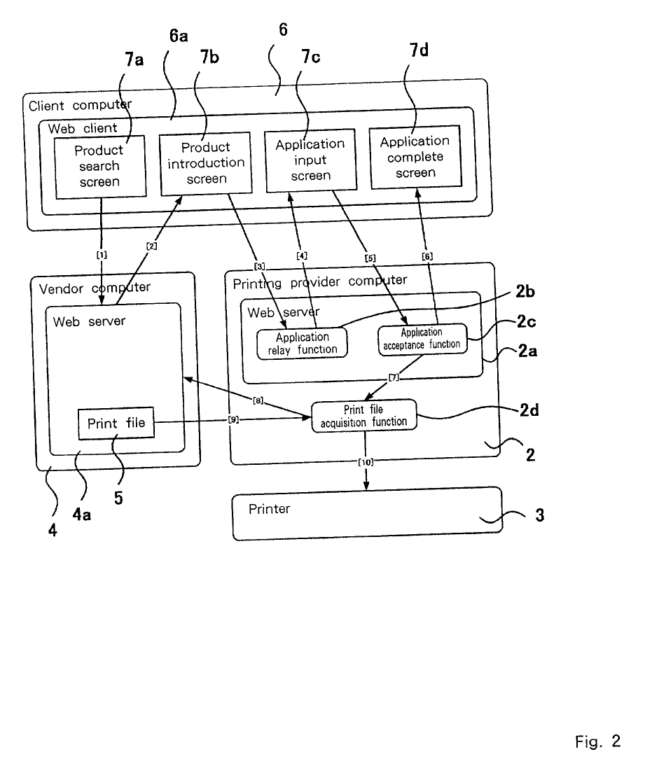

FIG. 2 is a block diagram showing an example configuration for the printing provider computer 2, the vendor computer 4 and the client computer 6.

The printing provider computer 2 includes the functions of a web server 2a, which has an application relay function 2b and an application acceptance function 2c. The printing provider computer 2 also includes a print file acquisition function 2d.

A function of the web server 2a, as well as the general server, is the receipt of an HTTP (HyperText Transfer Protocol) request from a client, and the transmission of an HTML (HyperText Markup Language) or an XML (Extensible Markup Language) document in return. Or, the web server 2a can execute a predetermined program via an interface, such as a CGI (Common Gateway Interface), and return the results to the client. The application relay function 2b and the application acceptance function 2c employ the CGI function of the web server 2a.

As will be described later, the application relay function 2b is the CGI of the destination that is linked to an anchor tag embedded in the web page of the vendor computer 4. The application relay function 2b receives the attribute information as the attribute for a tag, and transmits to the client computer 6 the data entered using the application input screen. The attribute information includes the title of the electronic data to be printed along with its storage location. It should be noted that, as will be described later, the attribute data that is received can be included as a hidden tag for the input tag in the application input screen data.

A function of the application acceptance function 2c is the receipt of client information, such as the delivery destination of printed material, that is entered at the client computer 6, and the confirmation of the acceptance of the printing application. The intent of the application is confirmed by the acceptance of this client information, and upon the receipt of the application, printing is initiated by the printing provider.

The print file acquisition function 2d obtains a print file 5 from the vendor computer 4. This print file 5 is temporarily buffered in the printing provider computer 2.

The printer 3 is, for example, a well-known POD printer. When the print file 5 is transmitted to the printer 3 by the printing provider computer 2, the printer 3 begins printing under the control of the printing provider computer 2. It should be noted that there is no limitation placed on the kind of printer 3 that can be employed; it may be a POD printer, or another printer, such as an offset printer.

The vendor computer 4 includes a web server 4a, at which the print file 5 is stored. The function of the web server 4a is the same as the function of the web server 2a. As previously described, the print file 5 need not always be recorded in the system of the vendor computer 4.

The client computer 6 includes a web client 6a. The web client 6a, which is, for example, a common web browser, includes a function for issuing an HTTP request and for displaying an HTML or XML document. As will be described later, the web client 6a displays a product search screen 7a, a product introduction screen 7b, an application input screen 7c and an application complete screen 7d.

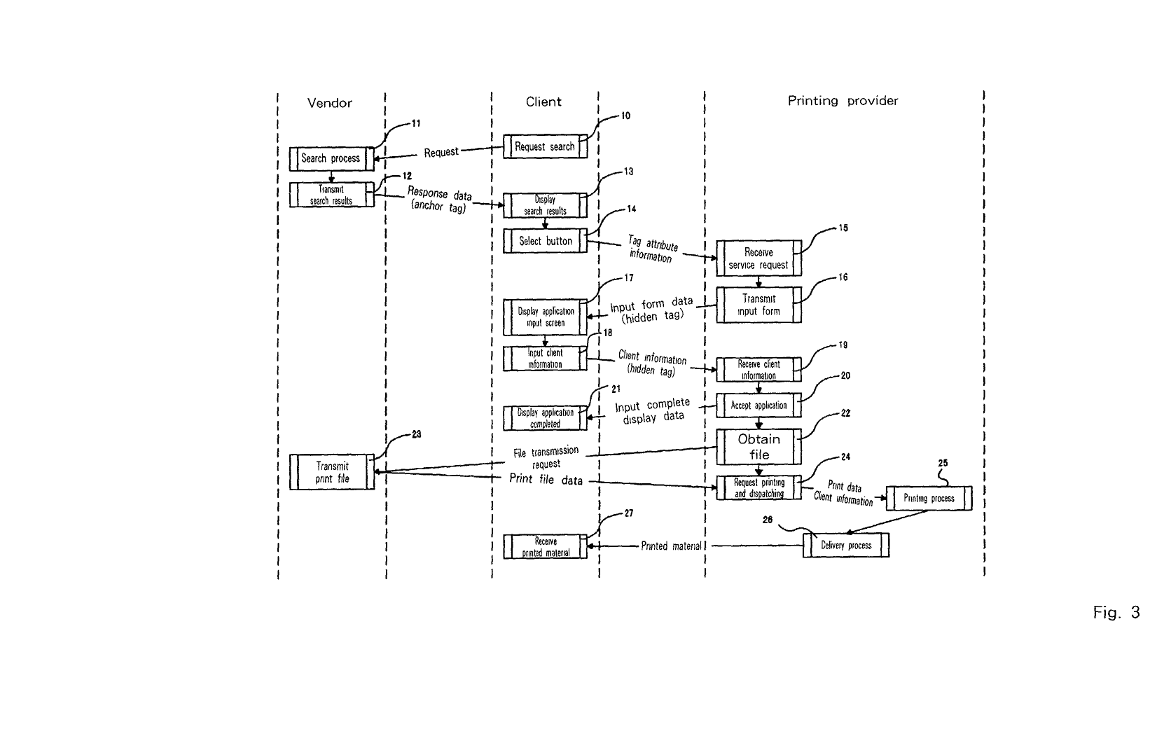

FIG. 3 is a flowchart showing an example of the information recording service provision method used in this embodiment. In FIG. 3, the process performed by the vendor computer 4 is shown on the left, the process performed by the client computer 6 is shown in the center, and the process performed by the printing provider computer 2 or the printing provider is shown on the right.

First, although not shown, the client accesses the vendor computer 4 web page, using a common, well known method, and displays the web page on the client computer 6. Assume that the client displays the product search screen following an arbitrary operation. In the explanation for this embodiment, the printing service is performed after the search is completed. However, no limitation is placed on when the printing service of this invention can be performed. A printing service button can be embedded in any web page, and so long as the button is embedded, the printing service of this invention can be initiated as the result of the performance of any arbitrary process.

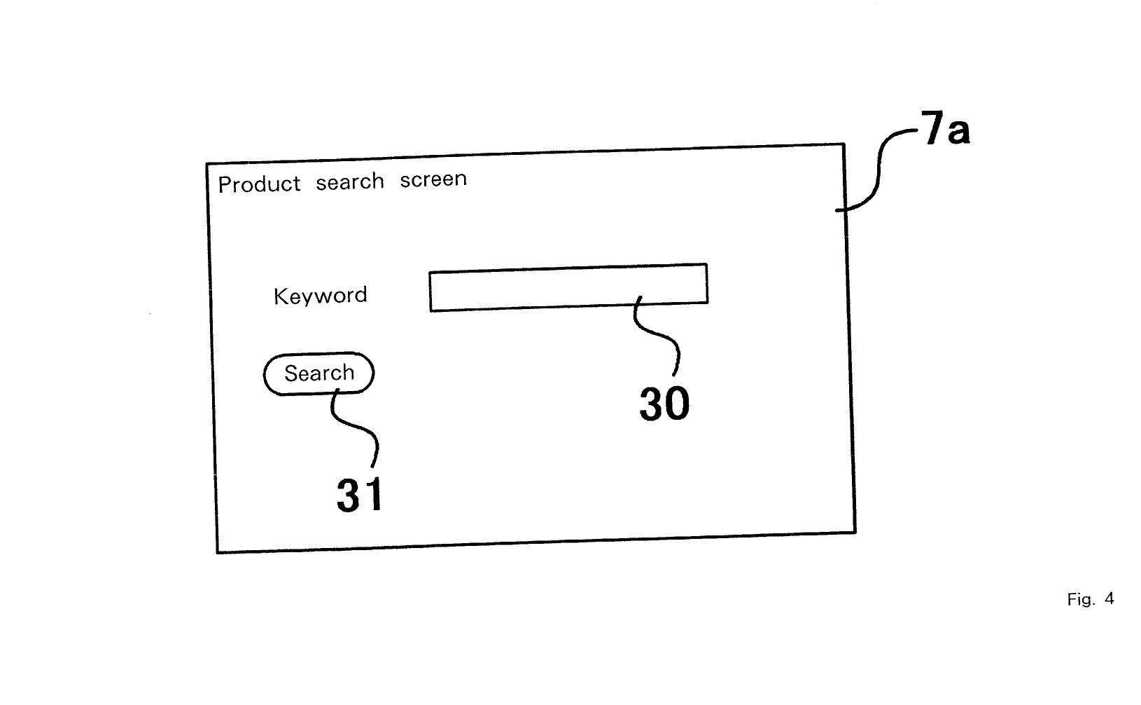

FIG. 4 is a diagram showing an example image for the product search screen 7a. An adequate keyword is entered in an input field 30, and a search button 31 is selected. In this manner, a search request is issued to the vendor computer 4 (step 10). For this selection, the arrow on the screen is moved to the button by using a pointing device, such as a mouse, and the mouse button is clicked. The same process is hereinafter performed for all selections.

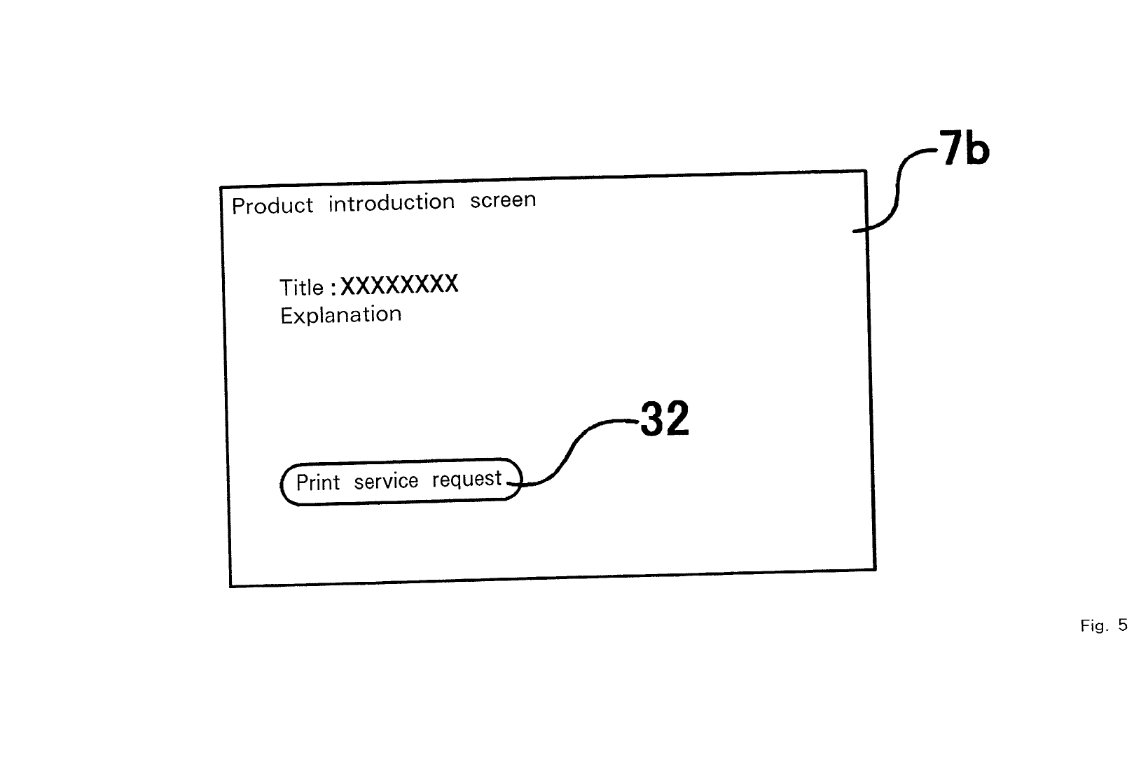

Upon receipt of the search request, the vendor computer 4 conducts a search (step 11), and transmits those search results that match the condition (keyword) to the client computer 6 (step 12). Thereafter, the client computer 6 displays the search results (step 13). FIG. 5 is a diagram showing an example product introduction screen 7b. On the product introduction screen 7b, the title or the description of a product and a printing service request button 32 are displayed. The data for the printing service request button 32 are originally included in the display data for the product information screen 7b received from the vendor computer 4, and an anchor tag for establishing a link is correlated with the printing service request button 32. An example anchor tag is as follows:

<a href=“http://printing provider

computer.co.jp/cgi-bin/TransOrder.cgi?&title=title&file
=http://vendor computer.co.jp/print file.pdf”>print
service request</a>

The address of the printing provider computer 2 that is included as the linking destination (http://printing provider computer.co.jp/cgi-bin/TransOrder.cgi), the title of the target data to be printed (title=title), and the file name of the target data indicated by the absolute path (file=http://vendor computer.co.jp/print file.pdf) are included as attributes in the start tag <a> of the anchor tag. When the printing service request button 32 is selected using the anchor tag, the process can be shifted to the printing provider computer 2, as the linking destination, together with the necessary information, so that the printing service can thereafter be smoothly performed. In order for the printing service to be provided for the client, the vender need only insert a sentence into the HTML document on the web page. Since the printing service provider (printing provider) offers a service that requires the vendor to assume only a small load, for the preparation of the pages used to request the use of the printing service, and since the dimensions of a button on the web page are such that it occupies only a limited area, the printing service will tend to be more frequently employed.

When the client selects the printing service request button 32 (step 14), an HTTP request (in the above example, a request for the execution of the Transorder.cgi program of absolute path //printing provider computer.co.jp/cgi-bin/) is issued to the printing provider computer 2 at the linking destination. That is, since the service provider computer 2 receives the service request (step 15), it transmits an input form to the requesting client computer 6 (step 16). For this transmission, in the input form data, the printing provider computer 2 can include, as hidden tags, the attribute information (the title and the file) received at step 15. Since the hidden tags are included, not only client information, which will be described later, will be obtained, but also, at the same time, necessary data will be obtained and the processing simplified. It should be noted that the processes at steps 15 and 16 are performed by the application relay function 2b. Example hidden tags are as follows:

<input type=hidden name=title value=“title”>
<input type=hidden name=file value=“http://vendor
computer.co.jp/print file.pdf”>

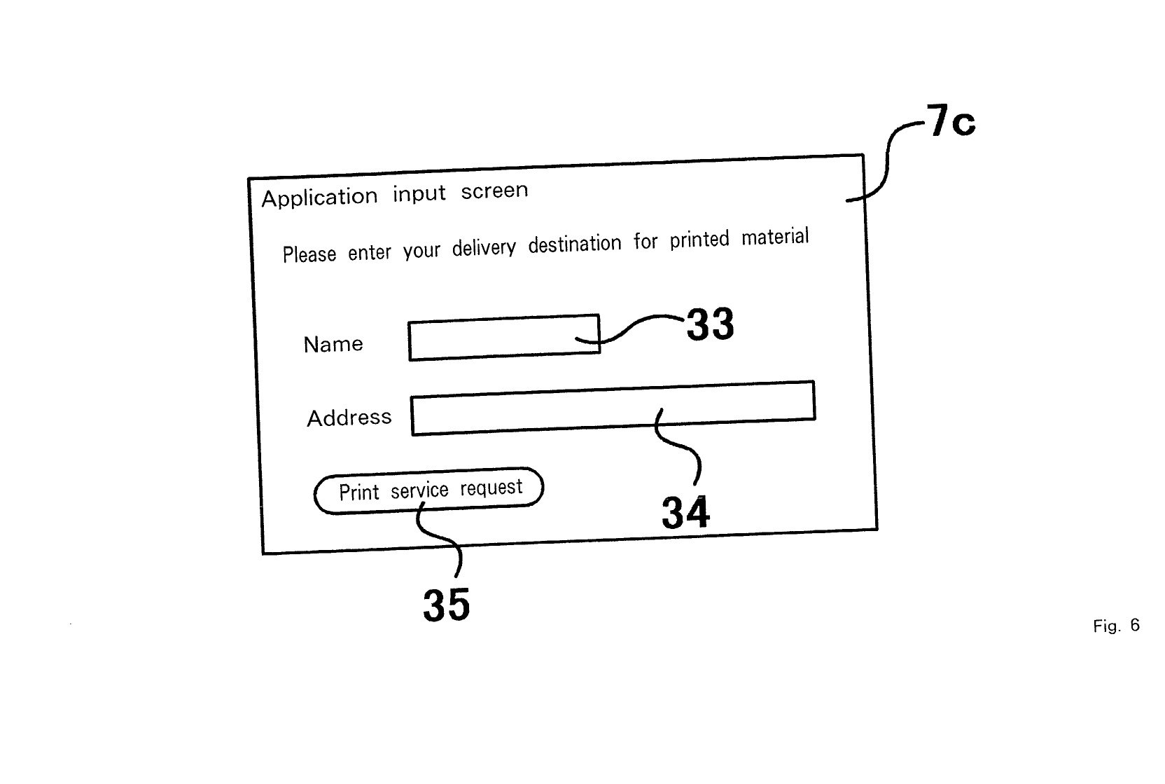

The input form data are displayed on the screen of the client computer 6 (step 17). FIG. 6 is a diagram showing an example application input screen 7c. The name and the address of the client are entered in input fields 33 and 34 (step 18). The information to be entered, however, is not limited to a client's name and address, and the client's e-mail address and other information may also be entered. Further, the name and the address of the client may be registered in advance, and this information may be identified by the entry of entering a client number issued at the time of registration.

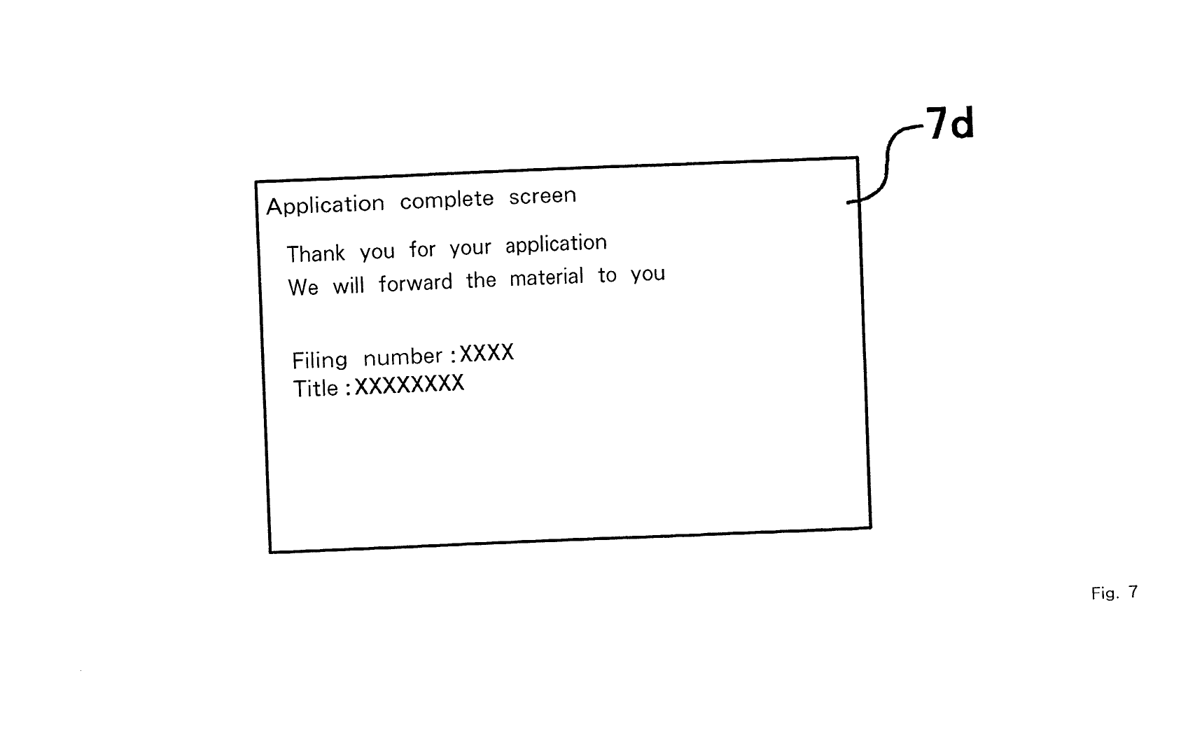

When the client has entered the required data in the input form and has selected a printing service request button 35, information, such as the client's name and address, is transmitted to the printing provider computer 2 (step 19). When hidden tags are attached, information concerning the target data, such as a title and a recording location, is received with the client information. The printing provider computer 2 then accepts the application (step 20), and transmits application complete display data to the client computer 6 as an application complete notification, which the client computer 6 thereafter displays (step 21). FIG. 7 is a diagram showing an example application complete screen 7d. It should be noted that the processes at steps 19 and 20 are performed by the application acceptance function 2c.

When the printing provider computer 2 transmits the application complete display data, it also acquires the print file 5 (step 22). During this process, the title name and the recording location (the file name represented in the absolute path) of the target file to be printed is transmitted by the application acceptance function 2c to the print file acquisition function 2d, which then refers to the recording location to obtain the print file 5 (step 23). According to the example anchor tag, electronic data having the file name “print file.pdf”, which is recorded in “//vendor computer.co.jp/”, is downloaded.

The obtained print file 5 is transmitted to the printer 3 (step 24), and is printed (step 25). Since a POD printer is employed in this explanation, the print file 5 is transmitted to the printer 3. However, were another method, such as offset printing, to be employed, a different, appropriate printing process would be performed.

The printed material obtained through the printing process is then delivered (step 26). During the delivery process, the printed material is forwarded to the address that is included in the client information obtained for the client who issued the order. Then, after the printed material has been received by the client (step 27), the processing sequence is terminated.

According to the printing service provision method and system of this invention, a tag for establishing a link with a printing provider computer need only be inserted into the web page of a vendor, so that the vendor, by employing his or her web page, can easily provide a printing service. The vendor need not be assume responsibility for the acceptance of a printing request, the transmission of a delivery destination information notification to a printing applicant (client), or the provision of the latest print data. The vendor need only add an anchor tag to his or her web page, and transmit an updated file to a predetermined directory (recording location). Therefore, the vendor can be relieved of almost all responsibility for the management of a printing service job.

Further, since the printing provider employs a standardized input form to uniformly provide printing services, and since the printing provider obtains client information and a print file each time an application is accepted, the printing provider need not assume responsibility for the management of client information and of print files. Therefore, the operation performed by the printing provider can be simplified and management costs can be reduced. In addition, the printing provider can provide for the vendor a service that imposes almost no operational load on the vendor. Furthermore, since the printing service can be provided simply by embedding a printing service request button in a very limited area on the vendor's web page, the vendor can easily offer clients this advantageous service, and can use it to promote sales.

The client can simply accept the printing service, without being aware of which printing provider the application has been submitted to. Further, since the operating efficiency of the process has been improved, the client can expect to pay only a low service charge.

The present invention has been explained while referring to the embodiment described. However, the invention is not limited to this embodiment, and can be variously modified without departing from the scope of the invention.

In the above embodiment, at step 16, the title and the recording location of the print data are included as hidden tags in the input form data, but instead of the title and the recording location of the print data, a session ID can be included as a hidden tag. In this case, print data information, such as the title and the recording location that is transmitted following the selection of the printing service request button 32 at step 14, is recorded in correlation with the session ID. When the information is managed by using the session ID, multiple types of print data can be selected for the same session, and a shopping packet method, for example, can be employed to select print data. It should be noted that in this case, the application relay function 2d in FIG. 2 notifies the application acceptance function 2c of the recording location of the print file that is correlated with the session management ID.

Furthermore, in this embodiment, the printing service has been employed as a recording service. The service is not limited to this, and the present invention can also be applied for the service for recording electronic data on a recording medium, such as a CD-ROM or a DVD-ROM.

In addition, a PDF file has been used for the electronic data; however, the storage of the data is not limited to this usage, and a specific word processor file can also be used. Moreover, the electronic data is not limited to documents or drawing files, and music or moving picture data can also be employed for the recording service. Furthermore, an adequate accounting means may be provided for the printing provider computer for the collection of service charges.

The specific effects obtained by the present invention are as follows. An efficient recording service, such as the printing of electronic data that is read or distributed, can be provided. Further, although only an extremely small load is imposed on a vendor, a recording service, such as printing, can be provided. In addition, a standardized service provision method can be provided for a service provider, such as a printing provider, who provides an information recording service.

The present invention can be realized in hardware, software, or a combination of hardware and software. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after either or both of the following conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

What is claimed, is:

1. An information recording service provision method, comprising using a computer network whereon a service provider computer, which provides a service for recording documents, drawings and other information, a data provider computer, which provides target data for said information, and a client computer, which uses said service for recording said information, are interconnected, including the steps of:
upon the receipt of a request from said client computer, transmitting display data, including anchor information used to establish a link with said service provider computer, to said client computer;
displaying, on a display screen of said client computer, an image corresponding to said display data;
selecting from said displayed image text, or an image correlated with said anchor information;
in response to said selection, initiating a process in said linked service provider computer, and transmitting data for an information recording request screen to said client computer;
displaying said information recording request screen, and entering client information and other information;
transmitting said input client information to said service provider computer;
obtaining said target data at said service provider computer;
recording said target data; and
transmitting the recorded material to said client computer in accordance with said client information.

2. The information recording service provision method according to claim 1, wherein said anchor information includes address information for a linked destination, the title of said target data, a recording location and other attribute information.

3. The information recording service provision method according to claim 2, wherein said attribute information or a session management ID is included as a hidden tag on said information recording request screen, and wherein said attribute information or said session management ID is transmitted with said client information.

4. The information recording service provision method according to claim 3, wherein said attribute information is correlated with said session management ID, and wherein said target data is obtained by referring to the recording location of said target data included in said attribute information transmitted with said client information, or said attribute information correlated with said session management ID.

5. An information recording service provision method comprising the steps of:
receiving a request from a client; and
transmitting with product information and other information, in response to said request, data for displaying, on the display screen of the computer of said client, text or an image that triggers the acceptance of an information recording service for said product information,
wherein said text or said image is correlated with anchor information for establishing a link with a computer of a service provider, which will provide an information recording service.

6. The information recording service provision method according to 5, wherein said anchor information includes address information for a linked destination, the title of said target data, and a recording location and other attribute information.

7. An information recording service provision method comprising the steps of:
transmitting computer data, for an information recording request screen, to a client in response to a selection of text or an embedded image, on a web page of said data provider computer, that is correlated with anchor information used by said service provider computer to prepare a link to enable the provision of an information recording service;
receiving client information entered by said client computer;
referring to attribute information, included in said client information, for target data that will enable said information recording service to obtain said target data;
recording said target data; and
transmitting said recorded material to said client computer in accordance with said client information.

8. The information recording service provision method according to claim 7, wherein said attribute information or a session management ID is included as a hidden tag on said information recording request screen, and wherein said attribute information or said session management ID is transmitted with said client information.

9. The information recording service provision method according to claim 8, wherein said attribute information is correlated with said session management ID, and wherein said target data is obtained by referring to the recording location of said target data included in said attribute information transmitted with said client information, or said attribute information correlated with said session management ID.

10. The information recording service provision method according to claim 1, wherein said information recording service is provided for the printing of said target data on paper, or for the recording of said target data on a recording medium.

11. An information recording service provision system, including a service provider computer, for providing a recording service for recording documents, drawings and other information, a data provider computer, for providing target data for said information, a client computer, for using said service to record said information, and a network, for connecting said computers, comprises:
means for, upon the receipt of a request from said client computer, transmitting display data, including anchor information used to establish a link with said service provider computer, to said client computer;
means for displaying, on a display screen of said client computer, an image corresponding to said display data;
means for selecting from said displayed image text, or an image correlated with said anchor information;
means for, in response to said selection, initiating a process in said linked service provider computer, and transmitting data for an information recording request screen to said client computer;
means for displaying said information recording request screen, and entering client information and other information;
means for transmitting said input client information to said service provider computer;
means for obtaining said target data at said service provider computer;
means for recording said target data; and
means for transmitting the recorded material to said client computer in accordance with said client information.

12. The information recording service provision system according to claim 11, wherein said anchor information includes address information for a linked destination, the title of said target data, a recording location and other attribute information.

13. The information recording service provision system according to claim 12, wherein said attribute information or a session management ID is included as a hidden tag on said information recording request screen, and wherein said attribute information or said session management ID is transmitted with said client information.

14. The information recording service provision system according to claim 13, wherein said attribute information is correlated with said session management ID, and wherein said target data is obtained by referring to the recording location of said target data included in said attribute information transmitted with said client information, or said attribute information correlated with said session management ID.

15. An information recording service provision system comprising:
means for receiving a request from a client; and
means for transmitting with product information and other information, in response to said request, data for displaying, on the display screen of the computer of said client, text or an image that triggers the acceptance of an information recording service for said product information,
wherein said text or said image is correlated with anchor information for establishing a link with a computer of a service provider, which will provide an information recording service.

16. The information recording service provision system according to 15, wherein said anchor information includes address information for a linked destination, the title of said target data, and a recording location and other attribute information.

17. An information recording service provision system comprising:
means for transmitting computer data, for an information recording request screen, to a client in response to a selection of text or an embedded image, on a web page of said data provider computer, that is correlated with anchor information used by said service provider computer to prepare a link to enable the provision of an information recording service;
means for receiving client information entered by said client computer;
means for referring to attribute information, included in said client information, for target data that will enable said information recording service to obtain said target data;
means for recording said target data; and
means for transmitting said recorded material to said client computer in accordance with said client information.

18. The information recording service provision system according to claim 17, wherein said attribute information or a session management ID is included as a hidden tag on said information recording request screen, and wherein said attribute information or said session management ID is transmitted with said client information.

19. The information recording service provision system according to claim 18, wherein said attribute information is correlated with said session management ID, and wherein said target data is obtained by referring to the recording location of said target data included in said attribute information transmitted with said client information, or said attribute information correlated with said session management ID.

20. The information recording service provision system according to claim 11, wherein said information recording service is provided for the printing of said target data on paper, or for the recording of said target data on a recording medium.

21. A computer-readable recording medium on which a program is recorded, said program permitting a computer to perform:
a function for receiving a request from a client; and
a function for transmitting with product information and other information, in response to said request, data for displaying, on the display screen of the computer of said client, text or an image that triggers the acceptance of an information recording service for said product information,
wherein said text or said image is correlated with anchor information for establishing a link with a computer of a service provider, which will provide an information recording service.

22. A computer-readable recording medium on which a program is recorded, said program permitting a computer to perform:
a function for transmitting computer data, for an information recording request screen, to a client in response to a selection of text or an embedded image, on a web page of said data provider computer, that is correlated with anchor information used by said service provider computer to prepare a link to enable the provision of an information recording service;
a function for receiving client information entered by said client computer; and
a function for referring to attribute information, included in said client information, for target data that will enable said information recording service to obtain said target data.

23. A computer program product permitting a computer to perform:
a function for receiving a request from a client; and
a function for transmitting with product information and other information, in response to said request, data for displaying, on the display screen of the computer of said client, text or an image that triggers the acceptance of an information recording service for said product information,
wherein said text or said image is correlated with anchor information for establishing a link with a computer of a service provider, which will provide an information recording service.

24. A computer program product permitting a computer to perform:
a function for transmitting computer data, for an information recording request screen, to a client in response to a selection of text or an embedded image, on a web page of said data provider computer, that is correlated with anchor information used by said service provider computer to prepare a link to enable the provision of an information recording service;
a function for receiving client information entered by said client computer; and
a function for referring to attribute information, included in said client information, for target data that will enable said information recording service to obtain said target data.
